(19) United States
(12) Patent Application Publication
(10) Pub. No.: US 2007/0122582 A1
(43) Pub. Date: May 31, 2007

(54) Method and apparatus for producing a monocomposite for a tire component

(76) Inventor: James Alfred Benzing II, North Canton, OH (US)

Correspondence Address: THE GOODYEAR TIRE & RUBBER COMPANY;INTELLECTUAL PROPERTY DEPARTMENT 823, 1144 EAST MARKET STREET, AKRON, OH, 44316-0001, US

(21) Appl. No.: 11/540,408

(22) Filed: Sep. 29, 2006

Related U.S. Application Data
(60) Provisional application No. 60/740,920, filed on Nov. 30, 2005.

(51) Int. Cl. B32B 3/00

(52) U.S. Cl. 428/57; 264/175; 428/156

(57) ABSTRACT

A method and apparatus for producing a single layer of two or more elastomeric tire components is provided. The method includes the steps providing two or more elastomeric compositions to a nip of two calender rolls, calendering said elastomeric compositions to form a single layer of elastomeric material. A monocomposite elastomeric laminate comprised of a single layer of two or more elastomer composition strips, wherein each elastomer composition strip has a longitudinal axis and a side edge, wherein each elastomeric strip is joined at said side edges without overlapping.

This application claims the benefit of U.S. Provisional Application No. 60/740,920, filed Nov. 30, 2005.

### FIELD OF THE INVENTION

The present invention is directed towards tires and the manufacturing of tire components.

### BACKGROUND OF THE INVENTION

Historically the pneumatic tire has been fabricated as a laminate structure of generally toroidal shape having beads, a tread belt reinforcement and a carcass. The tire is made of rubber, fabric and steel. Tire manufacturing generally involves manufacturing the individual tire components such as the innerliner, sidewalls, ply, and then layering each component on a tire building drum. Each component is cut to length and spliced together prior to the application of another component.

One disadvantage to the prior art process is that the tire carcass formed of the individual tire components has multiple splices. These splices may contribute to tire nonuniformity resulting in a higher rate of scrap tires. Eliminating the splices is one way to reduce tire nonuniformities. Another disadvantage to the prior art process is due to the fact that each tire component is separately manufactured to a given tire specification and then stored on wind-up trucks until application to the tire building drum. As a result, for a given tire configuration, there are multiple tire components which are stored in inventory. Thus to change tire configurations requires the changing out of all the premanufactured tire components.

Thus it is desired to provide a new and improved way of building tires where the number of tire splices is reduced resulting in more uniform tires and a more efficient, less costly way of building tires.

### SUMMARY OF THE INVENTION

The invention provides in a first aspect an apparatus for forming an elastomeric monocomposite of tire components, the apparatus comprising a first and second calender roll, each calender roll being rotatably mounted about its longitudinal axis, one or more elastomeric processors in fluid communication with a nip of said calender rolls, wherein one of said calender rolls has an outer projection.

The invention provides in a second aspect a monocomposite elastomeric laminate comprised of a single layer of two or more elastomer composition strips, wherein each elastomer composition strip has a longitudinal axis and a side edge, wherein each elastomeric strip is joined at said side edges without overlapping.

The invention provides in a third aspect a method of forming an elastomeric monocomposite of two or more tire components, the method comprising the steps of: providing two or more elastomeric compositions to a nip of two calender rolls, calendering said elastomeric compositions to form a single layer of elastomeric material.

### Definitions

For ease of understanding this disclosure, the following terms are disclosed:

“Axial” and “axially” mean lines or directions that are parallel to the axis of rotation of the tire;

“Bead” means that part of the tire comprising an annular tensile member wrapped by the carcass ply and shaped, with or without other reinforcement elements such as flippers, chippers, apexes, toe guards and chafers, to fit the design rim;

“Belt or breaker reinforcing structure” means at least two layers of plies of parallel strands, woven or unwoven, underlying the tread, unanchored to the bead;

“Cable” means at least two strands bunched or stranded together to form a reinforcing structure;

“Circumferential” means lines or directions extending along the perimeter of the surface of the annular tread perpendicular to the axial direction;

“Equatorial plane (EP)” means the plane perpendicular to the tire's axis of rotation and passing through the center of its tread;

“Filament” means a generic term for a continuous strand;

“Nominal rim diameter” means the diameter of the rim base at the location where the bead of the tire seals;

“Normal inflation pressure” refers to the specific design inflation pressure at a specific load assigned by the appropriate standards organization for the service condition for the tire;

“Normal load” refers to the specific load at a specific design inflation pressure assigned by the appropriate standards organization for the service condition for the tire;

“Ply” means a continuous layer of rubber-coated parallel strands;

“Radial” and “radially” mean directions extending radially toward or away from the axis of rotation of the tire; and

“Strand” means a reinforcing structure formed of at least one filament. A strand may be used alone for reinforcing or multiple strands may be grouped together to form a cable.

### BRIEF DESCRIPTION OF THE DRAWINGS

The invention will be described by way of example and with reference to the accompanying drawings in which:

FIG. 1 is a perspective view of calendering system of the present invention;

FIG. 2 is a side view of only the calender rolls of the invention shown in FIG. 1;

FIG. 3 is a perspective view of a one piece sheet of a tire component laminate produced by the calendering system of FIG. 1;

FIG. 4 is a close up perspective view of the tire component laminate showing the beveled area;

FIG. 5 is a perspective view of the tire component laminate just prior to assembly of the ends together;

FIG. 6 is an alternate embodiment of the calender rolls of the present invention;

FIG. 7 is a first embodiment of the laminate composite of the present invention; and

FIG. 8 is a second embodiment of the laminate composite of the present invention.

### DETAILED DESCRIPTION OF THE INVENTION

The following language is of the best presently contemplated mode or modes of carrying out the invention. This description is made for the purpose of illustrating the general principals of the invention and should not be taken in a limiting sense. The scope of the invention is best determined by reference to the appended claims.

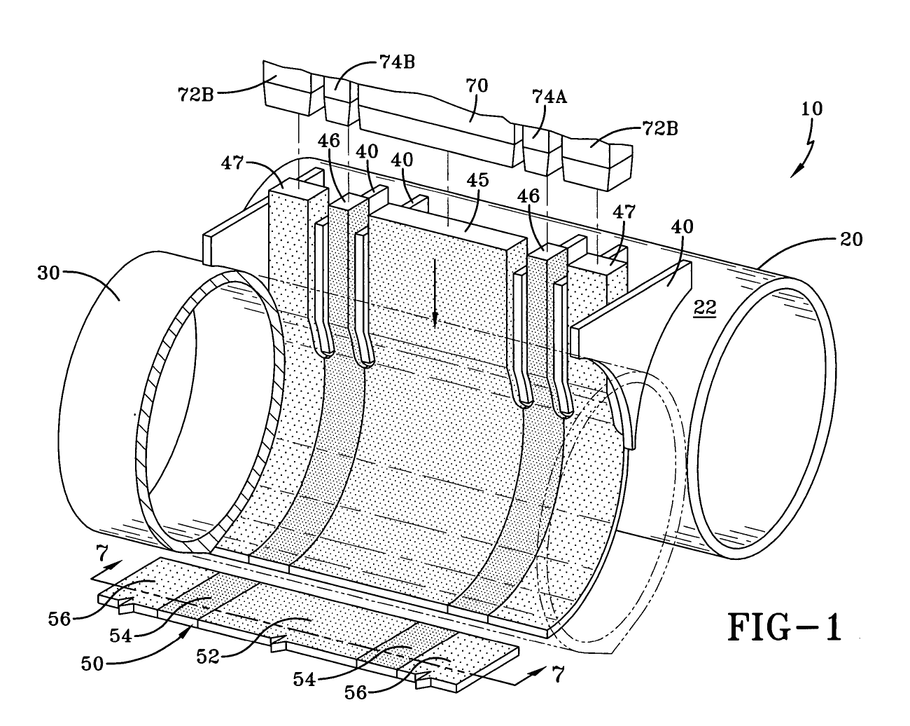

FIG. 1 illustrates a first embodiment of a calendering apparatus 10 of the present invention is shown. The calendering apparatus 10 includes a first calender roll 20 having a long cylindrical shape and having an outer surface 22. The calendering apparatus further includes a second calender roll 30 located adjacent and in parallel alignment for mating engagement with said first calender roll 20. Each calender roll 20, 30 is rotatably mounted to rotate about its longitudinal axis.

Interposed between the two calender rolls 20, 30 are one or more plows 40. Located near the calender rolls 20, 30 are two or more extruders, gear pumps, injectors or other means 70, 72, 74 for providing processed elastomeric material to the nip of the calender rolls 20, 30. The plows 40 separate two or more compound feed strips for each tire component. In one example, there is an innerliner feed strip 45 for forming an innerliner, two chafer feed strips 46, and two sidewall feed strips 47. Each strip 45, 47 may have a different compound composition depending upon the desired component characteristics. During calendering, the different compounds flow together to form a smooth monocomposite continuous sheet 50 of tire components. The interface or adjoining edges between the tire components may be about parallel to the longitudinal axis of the sheet 50. Alternatively, the interface may be formed at an angle by angling the tips of the plows (not shown).

Preferably, the calender roll 30 is divided into sections which corresponds to a different tire component. Each calender section is contoured to a predetermined profile for the selected tire component. For example, the inner section of the calender roll 30 corresponds to the innerliner 52. The outer sections correspond to formation of the tire sidewalls 56, and have an outer contour to form the desired shape of the sidewalls. The contoured calender roll 30 further has two sections located between the inner liner section and the sidewall sections, which correspond to formation of the tire chafers 54, located between the inner liner 52 and the sidewalls 56 on the monocomposite 50.

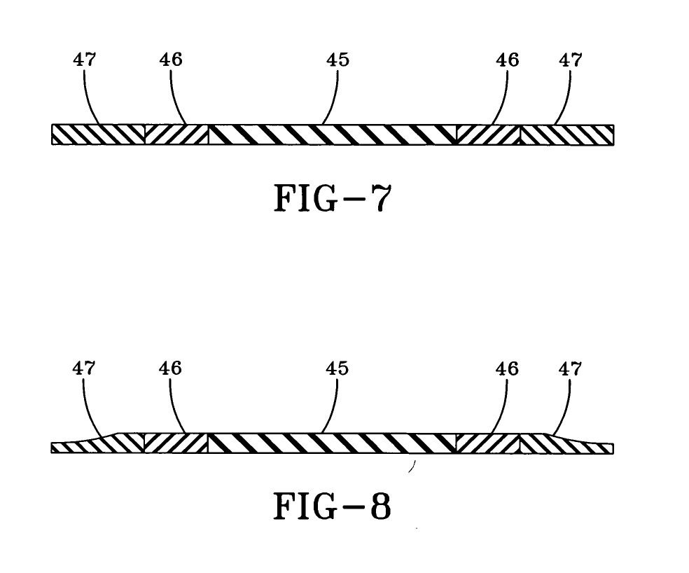

FIG. 3 illustrates the monocomposite sheet 50 of tire components produced by the calendering apparatus 10 of the invention. The monocomposite sheet 50 as shown, has an innerliner 52, on either end of the innerliner are optional chafers 54, and sidewalls 56. The tire components may have a flat cross-sectional profile as shown in FIG. 7. Alternatively, each tire component may have its unique cross-sectional profile. FIG. 8 illustrates an embodiment of the monocomposite sheet wherein the sidewalls are contoured.

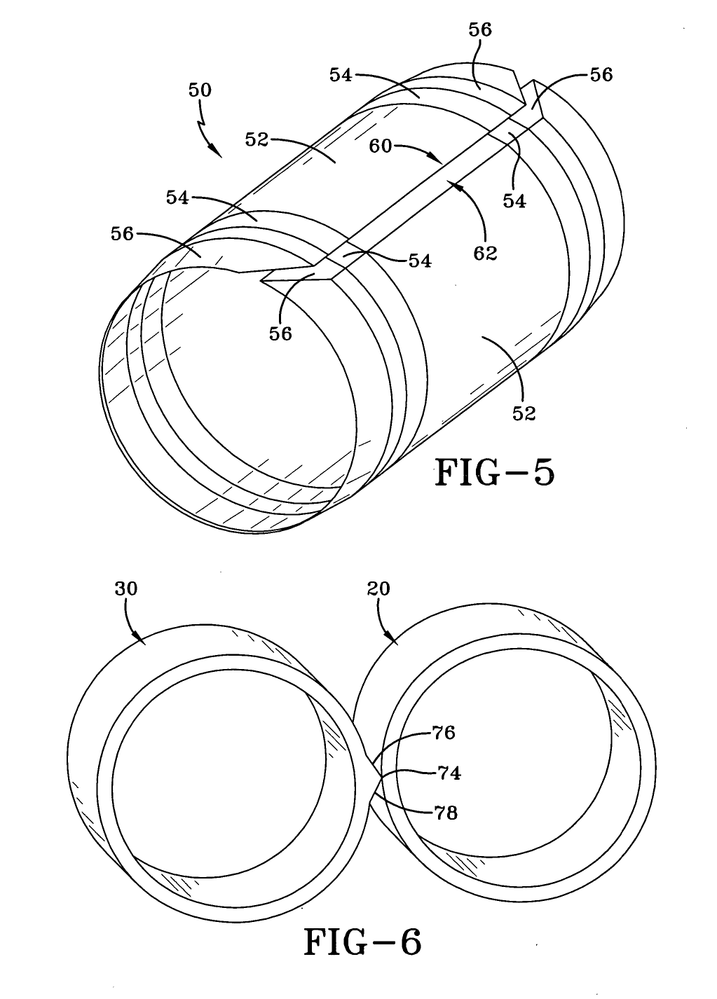

As shown in FIG. 3, the monocomposite sheet 50 further includes beveled ends 60, 62. A conventional cutter such as a hot knife may be used to cut the monocomposite sheet along web cut line 63 to form strips of a desired length. The cut line between the beveled ends is about 0.005 to about 0.007 inches thick, to maintain the continuous process. The strips have beveled ends 60, 62 which may be lap spliced together on the tire building drum as shown in FIG. 5.

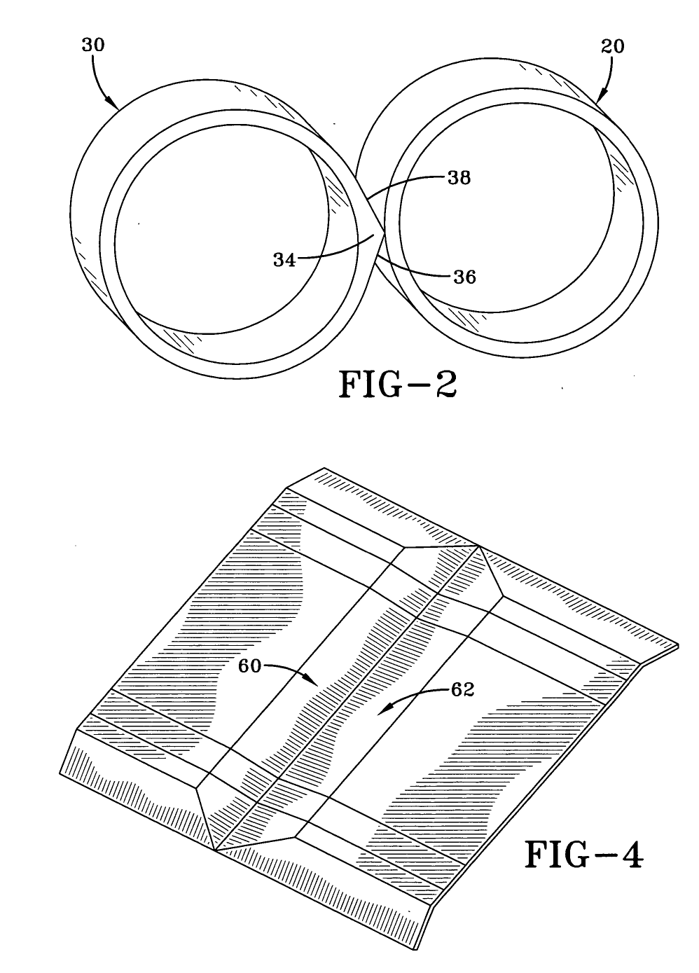

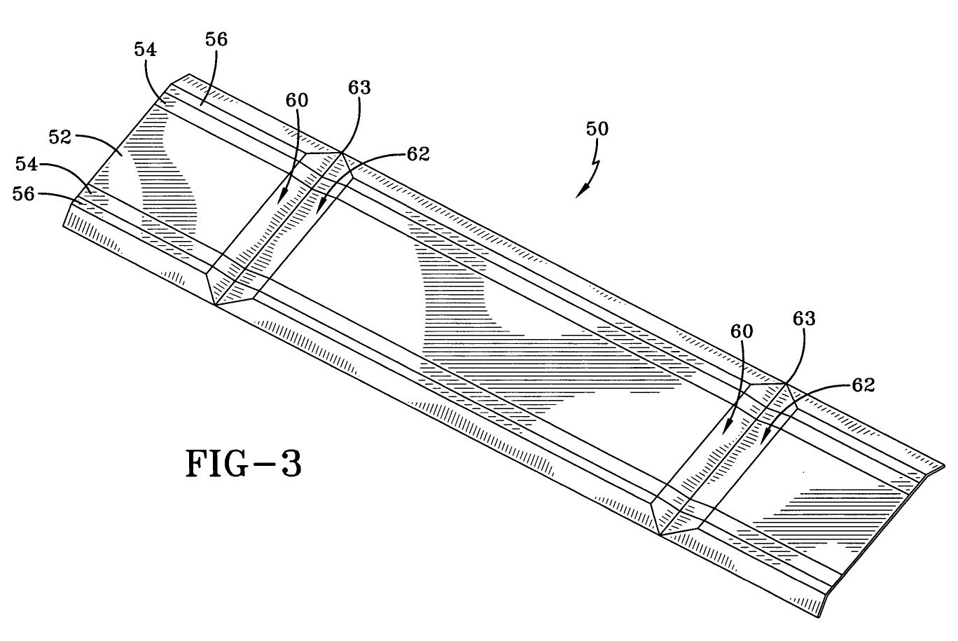

The beveled ends 60, 62 are formed on the calender rolls 30, 32. As shown in FIG. 2, the second calender roll 30 has a contoured outer surface 32, with an outer projection 34. Outer projection 34 has outer inclined sidewalls 36, 38 to produce a beveled splice area 60, 62 on the monocomposite as shown in FIG. 4. FIG. 6 is an alternate embodiment of the calender roll system showing an outer projection 74 having steeper angled sidewalls 76, 78. The angle of the bevel splice i.e., length of the sidewalls 60, 62 and consequently the angle of the bevel 60,62 of the sheet 50 can vary depending on different bead diameters or tire size. For example, a 20-inch diameter bead may have a 12.5 inch long splice, while a 16-inch diameter bead may have a 25 inch long splice. The angle of the splice may typically be in the range of about 1 to about 15 degrees, more typically in the range of about 3 to about 8 degrees.

While certain representative embodiments and details have been shown for the purpose of illustrating the invention, it will be appreciated there are still in the art various changes and modifications may be made therein without departing from the spirit or scope of the invention.

What is claimed is:

1. An apparatus for forming an elastomeric monocomposite of tire components, the apparatus comprising:
a first and second calender roll, each calender roll being rotatably mounted about its longitudinal axis, one or more elastomeric processors in fluid communication with a nip of said calender rolls, wherein one of said calender rolls has an outer projection.

2. The apparatus of claim 1 wherein the outer projection extends substantially along the longitudinal length of the calender roll.

3. The apparatus of claim 1 wherein a plurality of elastomeric processors is in fluid communication with said nip of said calender rolls.

4. The apparatus of claim 1 wherein the calender roll has a plurality of sections, each section having a contoured profile.

5. The apparatus of claim 1 wherein the calender roll has a plurality of sections, each section having a contoured profile for shaping a tire component.

6. The apparatus of claim 1 wherein the outer projection is triangular shaped.

7. A monocomposite elastomeric laminate comprised of a single layer of two or more elastomer composition strips, wherein each elastomer composition strip has a longitudinal axis and a side edge, wherein each elastomeric strip is joined at said side edges without overlapping.

8. The laminate of claim 7 wherein the side edges are parallel to the longitudinal axis.

9. The laminate of claim 7 wherein the side edges are not parallel to the longitudinal axis.

10. The laminate of claim 7 having a middle section having a first elastomeric composition, two outer sections having a second elastomeric composition and a third intermediary section having a third elastomeric composition located between said middle section and said outer sections.

11. The laminate of claim 10 wherein at least two of said sections have a different cross-sectional profile.

12. A method of forming an elastomeric monocomposite of two or more tire components, the method comprising the steps of: providing two or more elastomeric compositions to a nip of two calender rolls, calendering said elastomeric compositions to form a single layer of elastomeric material.

13. The method of claim 12 further comprising the step of forming a bevel in said single layer of elastomeric material.

14. The method of claim 12 wherein the elastomeric compositions are located adjacent each other prior to calendering.

15. The method of claim 12 wherein said calendering step further comprises calendering said first elastomeric composition to a first profile, and calendering said second elastomeric composition to a second profile.
